(19) United States
(12) Patent Application Publication
(10) Pub. No.: US 2024/0186485 A1
(43) Pub. Date: Jun. 6, 2024

(54) ANODE FOR LITHIUM SECONDARY BATTERY AND LITHIUM SECONDARY BATTERY INCLUDING THE SAME

(71) Applicant: SK ON CO., LTD., Seoul (KR)

(72) Inventors: Da Hye PARK, Daejeon (KR); Jun Hee HAN, Daejeon (KR); Moon Sung KIM, Daejeon (KR); Hyo Mi KIM, Daejeon (KR); Sang Baek RYU, Daejeon (KR); Seung Hyun YOOK, Daejeon (KR); Hwan Ho JANG, Daejeon (KR); Da Bin CHUNG, Daejeon (KR); Sang In BANG, Daejeon (KR)

(21) Appl. No.: 18/508,236

(22) Filed: Nov. 14, 2023

(30) Foreign Application Priority Data
Dec. 2, 2022 (KR) 10-2022-0166260

(51) Int. Cl. H01M 4/134; H01M 4/133

(52) U.S. Cl. CPC H01M 4/134; H01M 4/133; H01M 2004/027

(57) ABSTRACT

An anode for a lithium secondary battery includes an anode current collector, and a first anode active material layer and a second anode active material layer sequentially stacked on at least one surface of the anode current collector. The first anode active material layer and the second anode active material layer includes a first silicon-based active material and a second silicon-based active material, respectively.

### CROSS-REFERENCE TO RELATED APPLICATION AND CLAIM OF PRIORITY

This application claims priority to Korean Patent Applications No. 10-2022-0166260 filed on Dec. 2, 2022 in the Korean Intellectual Property Office (KIPO), the entire disclosure of which is incorporated by reference herein.

### BACKGROUND

### 1. Field

The present disclosure relates to an anode for a lithium secondary battery and a lithium secondary battery including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as an electric automobile.

Examples of the secondary battery includes, e.g., a lithium secondary battery, a nickel-cadmium battery, a nickel-hydrogen battery, etc. The lithium secondary battery is actively developed and applied due to high operational voltage and energy density per unit weight, a high charging rate, a compact dimension, etc.

For example, the lithium secondary battery may include an electrode assembly including a cathode, an anode and a separation layer (separator) interposed therebetween, and an electrolyte immersing the electrode assembly. The lithium secondary battery may further include an exterior material, e.g., in the form of a pouch, for accommodating the electrode assembly and the electrolyte.

Recently, as an application range of the lithium secondary battery has been expanded, developments of the lithium secondary battery having higher capacity and power are in progress. For example, a silicon-based active material providing a higher capacity may be used together with a carbon-based active material as an anode active material.

However, the silicon-based active material may cause a volume expansion and a life-span degradation due to side reactions with an electrolyte solution.

### SUMMARY

According to an aspect of the present disclosure, there is provided an anode for a lithium secondary battery having a multi-layered anode active material layer.

According to an aspect of the present invention, there is provided a lithium secondary battery including the anode.

An anode for a lithium secondary battery includes an anode current collector, and a first anode active material layer and a second anode active material layer sequentially stacked on at least one surface of the anode current collector. The first anode active material layer and the second anode active material layer includes a first silicon-based active material and a second silicon-based active material, respectively. The anode satisfy Formulae 1 to 3.

30<R₁<50 [Formula 1]

50<R₂<70 [Formula 2]

2.0≤(S₂R₂/S₁R₁)≤8.0 [Formula 3]

In Formulae 1 to 3, R₁ is a numerical percentage value of a thickness of the first anode active material layer relative to a total thickness of the first anode active material layer and the second anode active material layer. R₂ is a numerical percentage value of a thickness of the second anode active material layer relative to the total thickness of the first anode active material layer and the second anode active material layer. S₁ is a weight percent value of the first silicon-based active material based on a total weight of the first negative active material layer. S₂ is a weight percent value of the second silicon-based active material based on a total weight of the second negative active material layer. In some embodiments, each of the first silicon-based active material and the second silicon-based active material may include at least one selected from the group consisting of silicon, a silicon alloy, a silicon oxide, a metal-doped silicon oxide, a silicon carbide (Si—C) and a silicon-containing core-shell structure particle.

In some embodiments, the silicon oxide may include SiOx (0<x<2).

In some embodiments, the metal-doped silicon oxide may include SiOx (0<x<2) containing at least one doping metal selected from the group consisting of Mg, Li, N, B, P, Al, Cu, Mn, Ca and Zn.

In some embodiments, the first silicon-based active material and the second silicon-based active material may include SiOx (0<x<2) containing different doping metals.

In some embodiments, the doping metal of the first silicon-based active material may include Li, and the doping metal of the second silicon-based active material may include Mg.

In some embodiments, a sum of the thickness of the first anode active material layer and the thickness of the second anode active material layer may be in a range from 50 μm to 300 μm.

In some embodiments, S₁ may be in a range from 0.1 to 35, and S₂ may be in a range from 0.1 to 35.

In some embodiments, S₁ may be in a range from 1 to 15, and S₂ may be in a range from 1 to 20.

In some embodiments, the anode may satisfy Formula 4.

0.85≤(S₂/S₁)≤8.0. [Formula 4]

In some embodiments, each of the first anode active material layer and the second anode active material layer may further include a carbon-based active material.

In some embodiments, the carbon-based active material may include artificial graphite.

A lithium secondary battery includes the anode for lithium secondary battery according to the above-described embodiments, and a cathode facing the anode.

The anode for a lithium secondary battery according to embodiments of the present disclosure includes an anode active material layer having a multi-layered structure, and detachment of the active material layer may be prevented while enhancing cell performance.

The anode for a lithium secondary battery according to embodiments of the present disclosure contains a higher content of a silicon-based active material in an anode active material layer that is not in contact with an anode current collector than that in an anode active material layer contacting the anode current collector in consideration of a thickness of each layer. Accordingly, a high energy density-battery cell may be implemented.

The lithium secondary battery according to embodiments of the present disclosure includes the anode, thereby reducing a cell resistance and improving rapid charging performance and life-span properties.

The anode and the lithium secondary battery of the present disclosure may be widely applied in green technology fields such as an electric vehicle, a battery charging station, solar power generation wind power generation using batteries, etc. The anode and the lithium secondary battery according to the present disclosure may be used for eco-friendly electric vehicles and hybrid vehicles to prevent a climate change by suppressing air pollution and greenhouse gas emissions. etc.

### BRIEF DESCRIPTION OF THE DRAWINGS

FIG. 1 is a schematic cross-sectional view illustrating an anode for a lithium secondary lithium battery in accordance with example embodiments.

FIG. 2 is a schematic projection plan view illustrating a lithium secondary battery in accordance with example embodiments.

FIG. 3 is a schematic cross-sectional view illustrating a lithium secondary battery in accordance with example embodiments.

FIG. 4 is a graph showing DC-IR discharge resistances depending on an SOC of the batteries of Example 1 and Comparative Example 1.

### DETAILED DESCRIPTION OF THE EMBODIMENTS

According to embodiments of the present disclosure, an anode of a lithium secondary battery including a multi-layered anode active material layer, and a lithium secondary battery including the anode are provided.

Hereinafter, embodiments of the present disclosure will be described in detail with reference to exemplary embodiments and examples, and the accompanying drawings. However, those skilled in the art will appreciate that such embodiments and drawings are provided to further understand the spirit of the present invention and do not limit subject matters to be protected as disclosed in the detailed description and appended claims.

An anode for a lithium secondary battery according to embodiments of the present disclosure includes an anode current collector, and a first anode active material layer and a second anode active material layer sequentially stacked on at least one surface of the anode current collector. The first anode active material layer and the second anode active material layer may include a first silicon-based active material and a second silicon-based active material, respectively.

In example embodiments, the anode for a lithium secondary battery may include the first anode active material layer and the second anode active material layer sequentially stacked on one surface of the anode current collector. The anode for a lithium secondary battery may include the first anode active material layer and the second anode active material layer sequentially stacked on each of both surfaces of the anode current collector, respectively.

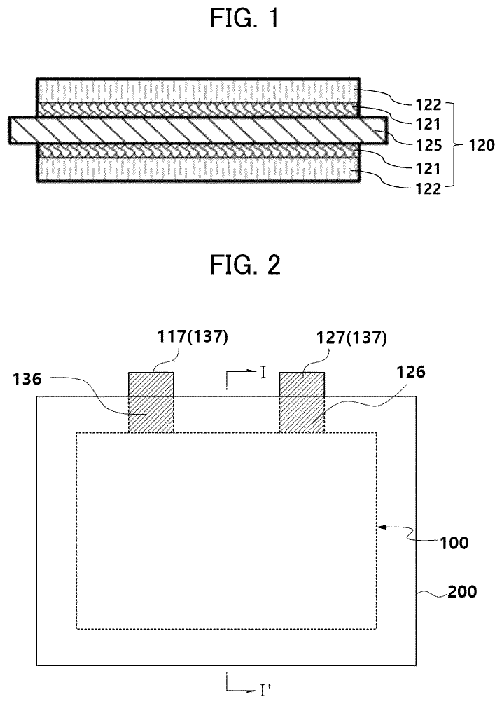

FIG. 1 is a schematic cross-sectional view illustrating an anode for a lithium secondary lithium battery in accordance with example embodiments.

Referring to FIG. 1, an anode 120 for a lithium secondary battery (hereinafter, abbreviated as an anode 120) may include a first anode active material layer 121 and a second anode active material layer 122 sequentially stacked on each of both surfaces of the anode current collector 125. The anode 120 may have a structure of the second anode active material layer 122—the first anode active material layer 121—the anode current collector 125—the first anode active material layer 121—the second anode active material layer 122.

In one embodiment, the first anode active material layer 121 and the second anode active material layer 122 on one surface of the anode current collector 125 may be omitted. In this case, the anode 120 may have a structure of the second anode active material layer 122—the first anode active material layer 121—the anode current collector 125.

In example embodiments, a thickness of the first anode active material layer 121 may be in a range from 0.1 μm to 100 μm, or from 1 μm to 30 μm. A thickness of the second anode active material layer may be in a range from 10 μm to 150 μm, or from 15 μm to 50 μm.

In example embodiments, the multi-layered anode active material layer may be employed so that a high-capacity lithium secondary battery may be effectively implemented.

In example embodiments, the first anode active material layer 121 and the second anode active material layer 122 may include a first silicon-based active material and a second silicon-based active material, respectively. The first silicon-based active material and the second silicon-based active material may be the same as each other or different from each other.

In example embodiments, the first silicon-based active material and the second silicon-based active material may each independently include at least one selected from the group consisting of silicon, a silicon alloy, a silicon oxide, a metal-doped silicon oxide, silicon carbide (Si—C) and a silicon-containing core-shell structure particle.

In some embodiments, the silicon oxide may include SiOx (0<x<2).

In some embodiments, the metal-doped silicon oxide may include SiOx (0<x<2) containing at least one doping metal selected from the group consisting of Mg, Li, N, B, P, Al, Cu, Mn, Ca and Zn

In some embodiments, the first silicon-based active material and the second silicon-based active material may include SiOx (0<x<2) containing different doping metals. The first anode active material layer 121 and the second anode active material layer 122 may include SiOx (0<x<2) containing different doping metals to provide high capacity and stability, respectively.

In some embodiments, the doping metal of the first silicon-based active material may include Li, and the doping metal of the second silicon-based active material may include Mg. In this case, the first anode active material layer 121 may have enhanced stability to be prevented from being detached from the anode current collector. Additionally, the second anode active material layer 122 may provide high-capacity properties.

In example embodiments, the anode 120 satisfies Formula 1 below.

30<R₁<50 [Formula 1]

In Formula 1, R₁ is a numerical percentage value of a thickness of the first anode active material layer 121 relative to a total thickness of the first anode active material layer 121 and the second anode active material layer 122.

In example embodiments, the anode 120 satisfies Equation 2 below.

50<R₂<70 [Formula 2]

In Formula 2, R₂ is a numerical percentage value of a thickness of the second anode active material layer 122 relative to the total thickness of the first anode active material layer 121 and the second anode active material layer 122.

In some embodiments, R₁ (%) may be in a range from 35 to 45, and R₂ (%) may be in a range from 55 to 65.

In example embodiments, the anode 120 satisfies Formula 3 below.

2.0≤(S₂R₂/S₁R₁)≤8.0 [Formula 3]

In Formula 3, R₁ and R₂ are as described above, S₁ is a weight percent numerical value of the first silicon-based active material based on a total weight of the first anode active material layer 121, and S₂ is a weight percent numerical value of the second anode active material layer 122 based on a total weight of the second anode active material layer 122.

In consideration of a thickness ratio of each layer, a content of the silicon-based active material content in the layer not in contact with the anode current collector (the second anode active material layer) and a content of the silicon-based active material in the layer in contact with the anode current collector (the first anode active material layer) may be adjusted according to Formula 3.

In example embodiments, the first anode active material layer 121 in contact with the anode current collector 125 may a relatively low silicon-based active material content to have increased adhesion to the anode current collector 125. Accordingly, detachment of the anode active material layer may be prevented and stability of the anode may be enhanced.

The second anode active material layer 122 formed on the surface of the first anode active material layer 121 which is not in contact with the anode current collector 125 may have a relatively increased silicon-based active material content to provide increased capacity.

However, the above-described effect may not be sufficiently achieved merely by adjusting the silicon-based active material content of the second anode active material layer 122 to be higher than that of the first anode active material layer 121. Additionally, the above-described effect may not be sufficiently achieved merely by adjusting the thickness of the second anode active material layer 122 to be greater than the thickness of the first anode active material layer 121.

In the anode 120 according to example embodiments of the present disclosure, the thickness and the content of the silicon-based active material of the first anode active material layer 121 and the thickness and the content of the silicon-based active material of the second anode active material layer 122 may be adjusted based on Formula 3. Accordingly, a high-capacity anode while also having improved stability may be implemented.

For example, even when using the same total content of the silicon-based active material included in the anode active material layer, a lithium secondary battery having more improved performance may be implemented by the anode satisfying Formula 3.

In example embodiments, the anode 120 may satisfy Formulae 1 to 3 above, and detachment of the active material layer in the anode 120 from the current collector 125 may be suppressed and a battery resistance may be reduced to improve a cell performance.

In example embodiments, the anode for a lithium secondary battery may satisfy Formula 3-1 below.

5.0≤(S₂R₂/S₁R₁)≤7.5 [Formula 3-1]

In Formula 3-1, R₁, R₂, S₁ and S₂ are as described above.

The anode for a lithium secondary battery may satisfy Formula 3-1, so that the battery having more improved capacity and stability may be provided.

The anode 120 satisfying Formulae Equations 1 to 3 may provide a battery having more enhanced performance compared to the case merely satisfying that the silicon-based active material content of the second anode active material layer is greater than the silicon-based active material content of the first anode active material layer, or the case merely using the same amount of the total content of the silicon-based active material based on a total weight of the entire anode active material layer.

The anode 120 according to example embodiments may satisfy Formula 4 below.

0.85≤(S₂/S₁)≤8.0 [Formula 4]

In Formula 4, S₁ and S₂ are as described above.

Even though the weight-based content (S₁) of the first silicon-based active material in the first anode active material layer 121 is greater than the weight-based content (S₂) of the second silicon-based active material of the second anode active material layer 122, the silicon-based active material content of the second anode active material layer 122 may be substantially greater when considering a thickness fraction of each layer.

In some embodiments, the anode 120 may satisfy Formula 4-1 below.

0.9≤(S₂/S₁)≤7.5 [Formula 4-1]

In Formula 4-1, S₁ and S₂ are as described above.

In example embodiments, S₁ may be in a range from 0.1 to 35 or from 1 to 15. In some embodiments, S₁ may be in a range from 2 to 15 or from 2 to 5.

S₂ may be in a range from 0.1 to 35 or from 1 to 20. In some embodiments, S₂ may be in a range from 3 to 20 or from 8 to 15.

In example embodiments, the first anode active material layer 121 and the second anode active material layer 122 may each further include a carbon-based active material.

The carbon-based active material may include a crystalline carbon-based active material or an amorphous carbon-based active material.

Examples of the crystalline carbon-based active material include natural graphite, artificial graphite, graphitized coke, graphitized mesocarbon microbeads, graphitized mesophase pitch-based carbon fiber, etc. These may be used alone or in a combination of two or more therefrom.

Examples of the amorphous carbon-based active material include hard carbon, coke, mesocarbon microbeads, mesophase pitch-based carbon fiber, etc. These may be used alone or in a combination of two or more therefrom.

In example embodiments, the carbon-based active material may include artificial graphite. In this case, chemical and mechanical stability and life-span properties of the anode may be entirely improved.

In example embodiments, the first anode active material layer 121 and the second anode active material layer 122 may each further include an additional active material. The additional active material may include, e.g., a lithium alloy.

For example, the lithium alloy may include a metal different from lithium to form an alloy with lithium. Examples of the metal different from lithium include aluminum, zinc, bismuth, cadmium, antimony, silicon, lead, tin, gallium, indium, etc. These may be used alone or in a combination of two or more therefrom.

In example embodiments, the first anode active material layer and the second anode active material layer may each further include an anode binder and a conductive material.

For example, the first silicon-based active material, a first additional active material, the anode binder, the conductive material, a dispersion medium, etc., may be mixed and stirred to from a first anode slurry. The first anode slurry may be coated on the anode current collector 125, and then dried and pressed to form the first anode active material layer 121.

The second silicon-based active material, a second additional active material, the anode binder, the conductive material, the dispersion medium, etc., may be mixed and stirred to from a second anode slurry. The second anode slurry may be coated on the first anode active material layer 121, and then dried and pressed to form the second anode active material layer 122.

In example embodiments, the first anode active material layer 121 and the second anode active material layer 122 may be sequentially formed on each of upper and lower surfaces of the anode current collector 125.

The anode current collector 125 may include gold, stainless steel, nickel, aluminum, titanium, copper, or an alloy thereof. For example, the anode current collector 125 may include copper or a copper alloy.

For example, the anode binder may include an organic binder such as polyvinylidene fluoride (PVDF), vinylidene fluoride-hexafluoropropylene copolymer (PVDF-co-HFP), polyacrylonitrile, polymethyl methacrylate, etc., or an aqueous binder such as styrene-butadiene rubber (SBR) that may be used with a thickener such as carboxymethyl cellulose (CMC).

For example, the conductive material may include a carbon-based conductive materials such as graphite, carbon black, graphene, carbon nanotube, etc., or a metal metal-based conductive materials such as tin, tin oxide, titanium oxide, a perovskite material such as LaSrCoO₃ and LaSrMnO₃.

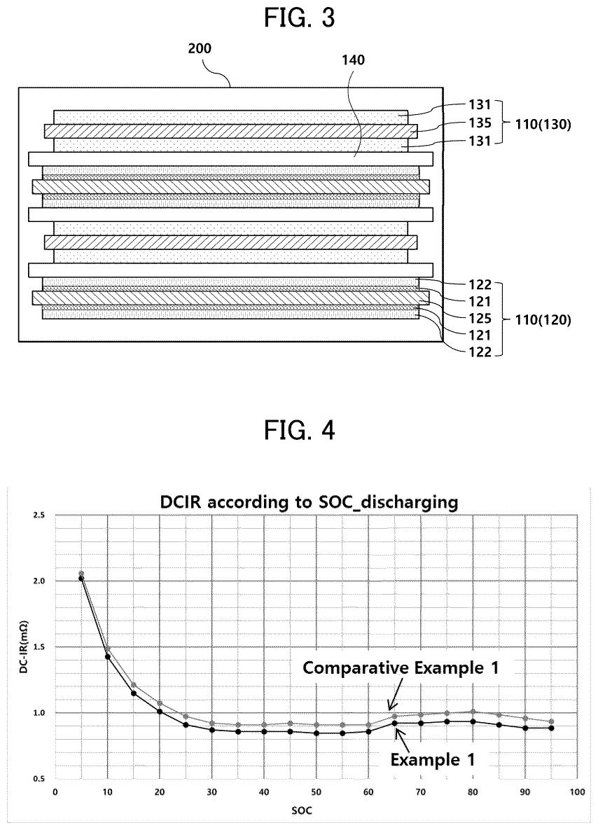

FIG. 2 is a schematic projection plan view illustrating a lithium secondary battery in accordance with example embodiments. FIG. 3 is a schematic cross-sectional view taken along a line I-I′ in a thickness direction.

Referring to FIGS. 2 and 3, a lithium secondary battery includes the anode 120 according to the above-described embodiments and a cathode 130 facing the anode 120.

The cathode 130 may include a cathode current collector 135 and a cathode active material layer 131 on the cathode current collector 135.

For example, the cathode active material layer 131 may include a cathode active material, and may further include a cathode binder and a conductive material.

For example, the cathode active material, the cathode binder, the conductive material, a dispersion medium, etc., may be mixed and stirred to form a cathode slurry. The cathode slurry may be coated on the cathode current collector 135, and then may be dried and pressed to form the cathode 130.

For example, the cathode current collector 135 may include stainless steel, nickel, aluminum, titanium, copper or an alloy thereof.

For example, the cathode active material may include lithium metal oxide particles capable of performing reversible insertion and desorption of lithium ions.

In an embodiment, the lithium metal oxide particle may contain nickel, cobalt, manganese, aluminum, etc.

In some embodiments, the lithium metal oxide particle may contain nickel, and a content of nickel in the lithium metal oxide particle may be 80 mol % or more of all elements excluding lithium and oxygen.

In some embodiments, the lithium metal oxide particle may be represented by LiNiO₂, LiCoO₂, LiMnO₂, LiMn₂O₄, or may include a chemical structure represented by Chemical Formula below.

[Chemical Formula]

LiₓNi_{(1-a-b)}CoₐM_{b}O_{y}

In the above Chemical Formula, M may include at least one of Al, Zr, Ti, Cr, B, Mg, Mn, Ba, Si, Y, W and Sr, and 0.9≤x≤1.2, 1.9≤y≤2.1 and 0≤a+b≤0.5.

In some embodiments, in the above Chemical Formula, 0<a+b≤0.4, 0<a+b≤0.3, 0<a+b≤0.2, or 0<a+b≤0.1.

The cathode binder and conductive material may include materials substantially the same as or similar to the anode binder and the conductive material, respectively, as described above. In some embodiments, the cathode binder may include an organic binder such as polyvinylidene fluoride (PVDF).

In some embodiments, an area of the anode 120 may be greater than that of the cathode 130. Accordingly, lithium ions generated from the cathode 130 may be easily transferred to the anode 120 without being precipitated.

In example embodiments, the lithium secondary battery may include a separation layer 140 interposed between the anode 120 and the cathode 130, and may further include an electrolyte solution.

For example, the separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, etc. The separation layer 140 may also include a non-woven fabric formed from a glass fiber with a high melting point, a polyethylene terephthalate fiber, etc.

For example, an electrode cell may be defined by the cathode 130, the anode 120 and the separation layer 140. A plurality of the electrode cells may be assembled to form an electrode assembly 100. For example, the electrode assembly 100 may be formed by winding, stacking z-folding, etc., of the separation layer 140.

A non-aqueous electrolyte solution may be used as the electrolyte solution. The non-aqueous electrolyte solution may contain a lithium salt as an electrolyte and an organic solvent. The lithium salt may be expressed as Li⁺X⁻, and an anion X⁻ of the lithium salt may include F, Cl⁻, Br, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

Examples of the organic solvent include propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethylsulfoxide, acetonitrile, dimethoxyethane, diethoxyethane, vinylene carbonate, sulfolane, gamma-butyrolactone, propylene sulfite, tetrahydrofuran, etc. These may be used alone or in a combination of two or more therefrom.

For example, the electrode assembly 100 and the above-described electrolyte solution may be accommodated together in a case 200 to form the lithium secondary battery.

The lithium secondary battery may be fabricated into a cylindrical shape, a prismatic shape, a pouch shape, a coin shape, etc.

The lithium secondary battery according to example embodiments may include an electrode lead 117 connected to an electrode 110 to protrude to an outside of the case 200.

The electrode lead 117 may include a cathode lead 137 connected to the anode 130 to protrude to the outside of the case 200, and an anode lead 127 connected to the anode 120 to protruded to the outside of the case 200.

For example, the cathode lead 137 may be electrically connected to the cathode current collector 135. The anode lead 127 may be electrically connected to the anode current collector 125.

The cathode current collector 135 of the cathode 130 and the anode current collector 125 of the anode 120 may each include a notched portion. The notched portion may be provided as, e.g., an electrode tab 116. The electrode tab 116 may include a cathode tab 136 and an anode tab 125.

For example, the cathode current collector 135 may include a cathode tab 136 at one side thereof. The cathode active material layer 131 may not be formed on the cathode tab 136. The cathode tab 136 may be integral with the cathode current collector 135 or may be connected to the cathode current collector 135 by, e.g., welding. The cathode current collector 135 and the cathode lead 137 may be electrically connected via the cathode tab 136.

The anode current collector 125 may include an anode tab 126 at one side thereof. The anode active material layer 121 and 122 may not be formed on the anode tab 126. The anode tab 126 may be integral with the anode current collector 125 or may be connected to the anode current collector 125 by, e.g., welding. The anode electrode current collector 125 and the anode lead 127 may be electrically connected via the anode tab 126.

The electrode assembly 150 may include a plurality of the cathodes and a plurality of the anodes. Each of the plurality of the cathodes may include the cathode tab. Each of the plurality of the anodes may include the anode tab.

The cathode tabs (or the anode tabs) may be laminated, pressed and welded to form a cathode tab stack (or an anode tab stack). The cathode tab stack may be electrically connected to the cathode lead 137. The anode tab stack may be electrically connected to the anode lead 127.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### Preparation Example 1

A silicon-based active material doped with lithium was prepared by adding and mixing lithium in an amount equivalent to 8 wt % of a total weight of a silicon-based active material with silicon oxide (SiOx, 0<x<2, D50: 6 μm).

Specifically, silicon and SiO₂ were mixed in a weight ratio of 1:1, and 8 wt % of lithium based on the total weight of the first silicon-based active material was mixed with silicon and SiO₂ to form a mixture.

The mixture was fired at a temperature of 1500° C. and then cooled to precipitate a silicon oxide composite containing lithium. The precipitated silicon oxide composite was pulverized and classified to prepare a silicon-based active material.

### Production Example 2

A silicon-based active material was prepared by the same method as that in Preparation Example 1, except that magnesium was used instead of lithium.

### Example 1

### (1) Fabrication of Anode

94.15 wt % of artificial graphite (D50: 20 μm) as a carbon-based active material, 2.00 wt % of the silicon-based active material of Preparation Example 1, 0.25 wt % of SWCNT as a conductive material, and 3.60 wt % of CMC/SBR (binder, 1.20/2.40 weight ratio) were added in water to prepare a first anode slurry.

87.15 wt % of artificial graphite (D50: 20 μm) as a carbon-based active material, 9.00 wt % of the silicon-based active material of Preparation Example 1, 0.25 wt % of SWCNT as a conductive material, and 3.60 wt % of CMC/SBR (binder, 1.20/2.40 weight ratio) were added in water to prepare a second cathode slurry.

The prepared first anode slurry was coated, dried, and pressed on one surface of a copper current collector (8 μm-thick copper foil) to form a first anode material layer.

The second anode slurry was coated, dried and pressed on the first anode active material layer to form a second anode active material layer.

A thickness ratio of the first anode active material layer and the second anode active material layer was 40:60.

### (2) Fabrication of Lithium Secondary Battery

A cathode slurry was prepared by mixing Li[Ni_{0.88}Co_{0.1}Mn_{0.02}]O₂ as a cathode active material, MWCNT as a conductive material, and polyvinylidene fluoride (PVDF) as a binder in a weight ratio of 98.08:0.72:1.2. The slurry was uniformly applied to a 12 μm-thick aluminum foil, and vacuum dried to prepare a cathode for a secondary battery. About 20 wt % of the MWCNT content was a content of a CNT dispersive agent.

The cathode and the anode prepared as described above were each notched by a predetermined size, and stacked with a separator (polyethylene, thickness: 13 μm) interposed therebetween to form an electrode cell. Each tab portion of the cathode and the anode was welded. The welded assembly of the cathode/separator/anode was inserted in a pouch, and three sides (sealing portion) of the pouch except for an electrolyte injection side were sealed. The tab portions were also included in the sealing portions. An electrolyte solution was injected through the electrolyte injection side, and

then the electrolyte injection side was also sealed. Impregnation was performed for 12 hours to obtain a lithium secondary battery.

In the preparation of the electrolyte solution, a 1M LiPF₆ solution was prepared using a mixed solvent of EC/EMC (25/75; volume ratio), and then 8 wt % of fluoroethylene carbonate (FEC), 0.5 wt % of 1,3-propenesultone (PRS) and 1.0 wt % of 1,3-propanesultone (PS) were added.

### Example 2

A lithium secondary battery was fabricated by the same method as that in Example 1, except that 93.98 wt % of artificial graphite and 2.17 wt % of the silicon-based active material of Preparation Example 1 were used when preparing the first anode slurry, 86.65 wt % of artificial graphite and 9.50 wt % of the silicon-based active material of Preparation Example 1 were used when preparing the second anode slurry, and the thickness ratio of the first anode active material layer and the second anode active material layer was 45:55.

### Example 3

A lithium secondary battery was fabricated by the same method as that in Example 1, except that 93.29 wt % of artificial graphite and 2.86 wt % of the silicon-based active material of Preparation Example 1 were used when preparing the first anode slurry, 88.15 wt % of artificial graphite and 8.00 wt % of the silicon-based active material of Preparation Example 1 were used when preparing the second anode slurry, and the thickness ratio of the first anode active material layer and the second anode active material layer was 35:65.

### Example 4

A lithium secondary battery was fabricated by the same method as that in Example 1, except that 91.87 wt % of artificial graphite and 4.28 wt % of the silicon-based active material of Preparation Example 1 were used when preparing the first anode slurry, 86.15 wt % of artificial graphite and 10.00 wt % of the silicon-based active material of Preparation Example 1 were used when preparing the second anode slurry, and the thickness ratio of the first anode active material layer and the second anode active material layer was 35:65.

### Example 5

A lithium secondary battery was fabricated by the same method as that in Example 1, except that 93.65 wt % of artificial graphite and 2.50 wt % of the silicon-based active material of Preparation Example 1 were used when preparing the first anode slurry, and 84.48 wt % of artificial graphite and 11.67 wt % of the silicon-based active material of Preparation Example 2 were used when preparing the second anode slurry.

### Comparative Example 1

A lithium secondary battery was fabricated by the same method as that in Example 1, except that 94.15 wt % of artificial graphite and 2.00 wt % of the silicon-based active material of Preparation Example 1 were used when preparing the first anode slurry, 82.15 wt % of artificial graphite and 14.00 wt % of the silicon-based active material of Preparation Example 1 were used when preparing the second anode slurry, and the thickness ratio of the first anode active material layer and the second anode active material layer was 65:35.

### Comparative Example 2

A lithium secondary battery was fabricated by the same method as that in Example 1, except that 87.65 wt % of artificial graphite and 8.50 wt % of the silicon-based active material of Preparation Example 1 were used when preparing the first anode slurry, 91.15 wt % of artificial graphite and 5.00 wt % of the silicon-based active material of Preparation Example 1 were used when preparing the second anode slurry, and the thickness ratio of the first anode active material layer and the second anode active material layer was 35:65.

### Comparative Example 3

A lithium secondary battery was fabricated by the same method as that in Example 1, except that 89.65 wt % of artificial graphite and 6.50 wt % of the silicon-based active material of Preparation Example 1 were used when preparing the first anode slurry, 90.15 wt % of artificial graphite and 6.00 wt % of the silicon-based active material of Preparation Example 1 were used when preparing the second anode slurry.

### Comparative Example 4

A lithium secondary battery was fabricated by the same method as that in Example 1, except that 90.93 wt % of artificial graphite and 5.22 wt % of the silicon-based active material of Preparation Example 1 were used when preparing the first anode slurry, 89.15 wt % of artificial graphite and 7.00 wt % of the silicon-based active material of Preparation Example 1 were used when preparing the second anode slurry, and the thickness ratio of the first anode active material layer and the second anode active material layer was 45:55.

### Comparative Example 5

A lithium secondary battery was fabricated by the same method as that in Example 1, except that 89.15 wt % of artificial graphite and 7.00 wt % of the silicon-based active material of Preparation Example 1 were used when preparing the first anode slurry, 87.15 wt % of artificial graphite and 9.00 wt % of the silicon-based active material of Preparation Example 1 were used when preparing the second anode slurry, and the thickness ratio of the first anode active material layer and the second anode active material layer was 50:50.

### Comparative Example 6

A lithium secondary battery was fabricated by the same method as that in Example 1, except that 89.15 wt % of artificial graphite and 7.00 wt % of the silicon-based active material of Preparation Example 1 were used when preparing the first anode slurry, 87.15 wt % of artificial graphite and 9.00 wt % of the silicon-based active material of Preparation Example 2 were used when preparing the second anode slurry, and the thickness ratio of the first anode active material layer and the second anode active material layer was 50:50.

The content of the silicon-based active material of Preparation Example 1 included in each anode slurry, the thickness ratio of each anode active material layer and a total content of the silicon-based active material in the entire anode active material layer of Examples and Comparative Examples are shown in Table 1 below. Further, evaluation results whether Formula 3 was satisfied are also shown as “O” and “X.”

2.0≤(S₂R₂/S₁R₁)≤8.0 [Formula 3]

TABLE 1
(30)

| | first anode active | | first anode active | | total | | |
|---|---|---|---|---|---|---|---|
| | material layer | | material layer | | (S₂R₂ + S₁R₁)/ | Formula 3 | |
| | S₁(wt %) | R₁(%) | S₂(wt %) | R₂(%) | 100% | S₂R₂/S₁R₁ | evaluation |
| Example 1 | 2.00 | 40 | 9.00 | 60 | 6.20 | 6.75 | ◯ |
| Example 2 | 2.17 | 45 | 9.5 | 55 | 6.20 | 5.35 | ◯ |
| Example 3 | 2.86 | 35 | 8.00 | 65 | 6.20 | 5.19 | ◯ |
| Example 4 | 4.28 | 35 | 10.00 | 65 | 8.00 | 4.34 | ◯ |
| * Example 5 | 2.50 | 40 | 11.67 | 60 | 8.00 | 7.00 | ◯ |
| Comparative | 2.00 | 65 | 14.00 | 35 | 6.20 | 3.77 | ◯ |
| Example 1 | | | | | | | |
| Comparative | 8.50 | 35 | 5.00 | 65 | 6.22 | 1.09 | X |
| Example 2 | | | | | | | |
| Comparative | 6.50 | 40 | 6.00 | 60 | 6.20 | 1.38 | X |
| Example 3 | | | | | | | |
| Comparative | 5.22 | 45 | 7.00 | 55 | 6.20 | 1.64 | X |
| Example 4 | | | | | | | |
| Comparative | 7.00 | 50 | 9.00 | 50 | 8.00 | 1.28 | X |
| Example 5 | | | | | | | |
| * Comparative | 7.00 | 50 | 9.00 | 50 | 8.00 | 1.28 | X |
| Example 6 | | | | | | | |

In Example 5 and Comparative Example 6, the magnesium-doped silicon oxide of Preparation Example 2 was used as the second silicon-based active material.

### Experimental Example 1: 10-Second Discharge Resistance (DCIR) Evaluation

The lithium secondary batteries of Example 1 and Comparative Example 1 were repeatedly 0.3 C CC/CV charged (4.2V 0.05 C CUT-OFF) and 0.5 CC CV discharged to measure a discharge capacity.

For an SOC 95 to an SOC 5, discharging with 0.3 C and an interval of SOC 5 was performed and a discharge resistance (DCIR) was measured for 10 seconds at 1 C in each SOC interval.

FIG. 4 shows a graph of DCIR discharge resistance according to the SOC of Example 1 and Comparative Example 1.

### Experimental Example 2: Evaluation on Detachment of Anode Active Material Layer

After a formation of the lithium secondary batteries of Examples and Comparative Examples, 0.3 C CC/CV charging (4.2V 0.05 C Cut-off) was performed, and then the lithium secondary batteries were disassembled.

An edge of the anode and/or an area adjacent to the anode tab were visually observed to confirm whether the anode active material layer was detached from the anode current collector. The results are shown in Table 2 below according to the following criteria.

Detachment of the anode active material layer was not observed: O

Detachment of the anode active material layer was observed: X

### Experimental Example 3: Evaluation on Rapid Charge Life-Span Property

A cycle of charging for 17 minutes in an SOC range of 8-80% and 0.3 C discharging was repeated 300 times for each lithium secondary battery of Examples and Comparative Examples. A discharge capacity retention relative to an initial discharge capacity was measured as a percentage.

### Experimental Example 4: Evaluation on Life-Span Property at Room Temperature (25° C.)

Life-span properties were evaluated for the lithium secondary batteries of Examples and Comparative Examples in an SOC range of 4-98% at 25° C. The battery was charged by 0.3 C to a voltage corresponding to an SOC98 under constant current/constant voltage (CC/CV) conditions, 0.05 C cut off, 0.3 C discharged to a voltage corresponding to an SOC4 under a constant current (CC) condition, and then an initial discharge capacity was measured. The above-described cycle was repeated 600 times and 1200 times, and discharge capacity retentions relative to an initial discharge capacity were measured as percentages. The sample having the capacity retention of 80% or less was determined as “poor.”

The results are shown in Table 2.

TABLE 2

| | | | room | room |
|---|---|---|---|---|
| | Detachment | rapid | temperature | temperature |
| | of anode | charge | capacity | capacity |
| | active | capacity | retention | retention |
| | material | retention | (600 cycles) | (1,200 cycles) |
| | layer | (%) | (%) | (%) |
| Example 1 | ◯ | 92.3 | 94.9 | 82.5 |
| Example 2 | ◯ | 91.6 | 94.4 | 81.1 |
| Example 3 | ◯ | 91.1 | 94.0 | poor |
| Example 4 | ◯ | 88.7 | 93.6 | poor |
| Example 5 | ◯ | 86.9 | 91.9 | 86.9 |
| Comparative | X | 90.6 | 93.0 | poor |
| Example 1 | | | | |
| Comparative | X | 88.4 | 92.1 | poor |
| Example 2 | | | | |
| Comparative | X | 88.9 | 92.5 | poor |
| Example 3 | | | | |
| Comparative | X | 89.3 | 92.8 | poor |
| Example 4 | | | | |
| Comparative | X | 86.2 | 91.4 | poor |
| Example 5 | | | | |
| Comparative | X | 84.5 | 91.4 | 85.0 |
| Example 6 | | | | |

Referring to FIG. 4, the lithium secondary battery of Example 1 provided lower discharge resistance and improved battery performance than those from the lithium secondary battery of Comparative Example 1.

Referring to Table 2, in the lithium secondary batteries of Examples 1 to 5 that satisfied Equations 1 to 3, detachment of the anode active material did not occur, and high capacity retention was provided even during rapid charge and discharge.

In Examples 1 to 4, improved 600-cycle room temperature capacity retentions was provided compared to those from Comparative Examples 1 to 5. In Example 5 and Comparative Example 6 where the magnesium-doped silicon oxide was used as the second silicon-based active material, the capacity retention in Example 5 was greater than that from Comparative Example 6.

In Example 5, the capacity maintenance after 1200 cycles was relatively increased compared to those from other Examples. It is predicted that long-term durability of the lithium secondary battery was improved by using the magnesium-doped silicon oxide as the second silicon-based active material.

In the lithium secondary batteries of Comparative Example 1 not satisfying Equations 1 and 2, and Comparative Examples 2 to 6 not satisfying Equation 3, detachment of the anode active material layer occurred, and the rapid charge capacity retention and room temperature life-span properties were deteriorated compared to those from Examples.

What is claimed is:

1. An anode for a lithium secondary battery, comprising:
an anode current collector; and
a first anode active material layer and a second anode active material layer sequentially stacked on at least one surface of the anode current collector, the first anode active material layer and the second anode active material layer comprising a first silicon-based active material and a second silicon-based active material, respectively,
wherein Formulae 1 to 3 are satisfied:
30<R₁<50 [Formula 1]
50<R₂<70 [Formula 2]
2.0≤(S₂R₂/S₁R₁)≤8.0 [Formula 3]
wherein, in Formulae 1 to 3, R₁ is a numerical percentage value of a thickness of the first anode active material layer relative to a total thickness of the first anode active material layer and the second anode active material layer,
R₂ is a numerical percentage value of a thickness of the second anode active material layer relative to the total thickness of the first anode active material layer and the second anode active material layer,
S₁ is a weight percent value of the first silicon-based active material based on a total weight of the first negative active material layer, and
S₂ is a weight percent value of the second silicon-based active material based on a total weight of the second negative active material layer.

2. The anode for a lithium secondary battery of claim 1, wherein each of the first silicon-based active material and the second silicon-based active material includes at least one selected from the group consisting of silicon, a silicon alloy, a silicon oxide, a metal-doped silicon oxide, a silicon carbide (Si—C) and a silicon-containing core-shell structure particle.

3. The anode for a lithium secondary battery of claim 2, wherein the silicon oxide includes SiOx (0<x<2).

4. The anode for a lithium secondary battery of claim 2, wherein the metal-doped silicon oxide includes SiOx (0<x<2) containing at least one doping metal selected from the group consisting of Mg, Li, N, B, P, Al, Cu, Mn, Ca and Zn.

5. The anode for a lithium secondary battery of claim 4, wherein the first silicon-based active material and the second silicon-based active material include SiOx (0<x<2) containing different doping metals.

6. The anode for a lithium secondary battery of claim 5, wherein the doping metal of the first silicon-based active material includes Li, and the doping metal of the second silicon-based active material includes Mg.

7. The anode for a lithium secondary battery of claim 1, wherein a sum of the thickness of the first anode active material layer and the thickness of the second anode active material layer is in a range from 50 μm to 300 μm.

8. The anode for a lithium secondary battery of claim 1, wherein S₁ is in a range from 0.1 to 35, and S₂ is in a range from 0.1 to 35.

9. The anode for a lithium secondary battery of claim 1, wherein S₁ is in a range from 1 to 15, and S₂ is in a range from 1 to 20.

10. The anode for a lithium secondary battery of claim 1, wherein Formula 4 is satisfied:
0.85≤(S₂/S₁)≤8.0. [Formula 4]

11. The anode for a lithium secondary battery of claim 1, wherein each of the first anode active material layer and the second anode active material layer further comprises a carbon-based active material.

12. The anode for a lithium secondary battery of claim 1, wherein the carbon-based active material comprises artificial graphite.

13. A lithium secondary battery, comprising:
the anode for lithium secondary battery of claim 1; and
a cathode facing the anode.
